(19) United States
(12) Patent Application Publication
(10) Pub. No.: US 2025/0131520 A1
(43) Pub. Date: Apr. 24, 2025

(54) SYSTEMS AND METHODS OF PREDICTING STUDENT RETENTION RATES

(71) Applicant: Rensselaer Polytechnic Institute, Troy, NY (US)

(72) Inventors: Jasmine Yang, Clifton Park, NY (US); Lu Enzhe, Piscataway, NJ (US); Jiarun Li, Troy, NY (US); Keith Moo-Young, Clifton Park, NY (US); Yihui Yang, Troy, NY (US); Hui Su, West Roxbury, MA (US); Yifan LIU, Albary, NY (US)

(73) Assignee: Rensselaer Polytechnic Institute, Troy, NY (US)

(21) Appl. No.: 18/835,804

(22) PCT Filed: Feb. 3, 2023
(86) PCT No.: PCT/US23/12296

§ 371 Date: Aug. 5, 2024

Related U.S. Application Data
(60) Provisional application No. 63/306,242, filed on Feb. 3, 2022.

(51) Int. Cl. G06Q 50/20; G06N 20/00

(52) U.S. Cl. CPC G06Q 50/205; G06N 20/00

(57) ABSTRACT

Systems and methods of predicting the retention rates of students attending an educational institution are provided. The method includes receiving an initial dataset related to a cohort of students attending the educational institution, dividing the initial dataset into a training dataset and a testing dataset, training a predictive algorithm via the training dataset to generate a prediction model, and processing the testing dataset via the prediction model to output a prediction results dataset. The prediction results dataset includes a listing of the cohort of students organized from most likely to leave the educational institution to least likely to leave the educational institution. The method includes filtering a percentage of the prediction results dataset to identify a watchlist of students likely to leave the educational institution.

### CROSS REFERENCE TO RELATED APPLICATION(S)

This application claims the priority benefit of U.S. Provisional Patent Application No. 63/306,242, filed Feb. 3, 2022, which is incorporated by reference as if disclosed herein in its entirety.

### FIELD

The present technology relates generally to the field of machine learning, and more particularly, to generating and training machine learning models to predict student retention rates for educational institutions.

### BACKGROUND

Educational institutions aim to achieve student success, meaning that the students are prepared for success in their personal, civic, and professional lives, and that they embody the values of their educational learning and experience. To achieve student success, educational institutions need to understand student satisfaction and their retention and attrition experiences. The process of student success typically uses early warning factors to determine risk levels such that intervention may occur early. Identification of students who need extra help requires buy-in from both academic affairs and students affairs. Traditionally, the process is long-term and participatory with wide representation from many campus constituencies who are non-analytic adept people.

However, process traditionally focuses on student retention rather than attrition, such that only students' existing successful experience was used to support students who might need extra help. This process fails to understand student attrition patterns due to issues with resonance studies. Additionally, the decentralized nature of the offices makes it difficult for different departments to coordinate data and their skills dynamically. This creates operational inefficiency which slows down the ability to respond to student problems. This decentralized process has also been resistant to the incorporation of machine-learning technologies.

What is needed, therefore, are improved systems and methods of predicting student retention rates that address at least the problems described above.

### SUMMARY

According to an embodiment of the present technology, a method of predicting the retention rates of students attending an educational institution is provided. The method includes receiving an initial dataset related to a cohort of students attending the educational institution, dividing the initial dataset into a training dataset and a testing dataset, training a predictive algorithm via the training dataset to generate a prediction model, and processing the testing dataset via the prediction model to output a prediction results dataset.

In some embodiments, the prediction results dataset includes a listing of the cohort of students organized from most likely to leave the educational institution to least likely to leave the educational institution. The method further includes filtering a percentage of the prediction results dataset to identify a watchlist of students likely to leave the educational institution. In some embodiments, the watchlist includes the top 15% of the cohort of students most likely to leave the educational institution.

In some embodiments, training the predictive algorithm includes processing the training dataset with the predictive algorithm to generate a training model, validating the training model, and generating the prediction model based on the validated training model.

In some embodiments, validating the training model includes dividing the training dataset into a plurality of subsets; randomly selecting a first of the plurality of subsets as a first test subset and selecting the remaining ones of the plurality of subsets as a first training subset; training the training model via the first training subsets to generate a first training sub-model; validating the first training sub-model via the first test subset; and repeating the randomly selecting, training, and validating steps for each of the remaining ones of the plurality of subsets to generate a plurality of validated training sub-models. In some embodiments, the prediction model includes a weighted combination of the plurality of validated training sub-models.

In some embodiments, the training dataset and the testing dataset are resampled from the initial dataset before the predictive algorithm is trained.

In some embodiments, the initial dataset includes admission data, academic data, and financial data for each student of the cohort of students.

In some embodiments, the method further includes preprocessing the initial dataset to filter and transform the initial dataset to a format compatible with the predictive algorithm.

In some embodiments, the method further includes receiving, after a predetermined period of time, an updated dataset related to the cohort of students; dividing the updated dataset into an updated training dataset and an updated testing dataset; retraining the predictive algorithm via the updated training dataset to generate an updated prediction model; and processing the updated testing dataset via the updated prediction model to output an updated prediction results dataset.

In some embodiments, the updated dataset includes updated admission data, updated academic data, and updated financial data for each student of the cohort of students still attending the educational institution after the predetermined period of time.

In some embodiments, the method further includes preprocessing the updated dataset to filter and transform the updated dataset to a format compatible with the predictive algorithm.

In some embodiments, the updated training dataset and the updated testing dataset are resampled from the updated dataset before the predictive algorithm is retrained.

In some embodiments, the method further includes receiving, in real-time, learning management system (LMS) data and early warning system (EWS) data for each student of the cohort of students; analyzing the LMS data and the EWS data; and adjusting the prediction results dataset based on the analyzed LMS data and EWS data.

In some embodiments, the training dataset includes 80% of the initial dataset and the testing dataset includes 20% of the initial dataset.

In some embodiments, the updated training dataset includes 80% of the updated dataset and the updated testing dataset includes 20% of the updated dataset.

According to another embodiment of the present technology, a computer readable storage device having stored thereon instructions that when executed by one or more processors result in performing the method of any of the embodiments described herein.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a flowchart showing a method of predicting the retention rates of students attending an educational institution according to an embodiment of the present technology.

FIG. 2 is a schematic showing a system of predicting the retention rates of students attending an educational institution according to an embodiment of the present technology.

FIG. 3 is a schematic showing a system of predicting the retention rates of students attending an educational institution according to another embodiment of the present technology.

FIG. 4 is a schematic showing the translation model used in the system of FIG. 2.

### DETAILED DESCRIPTION

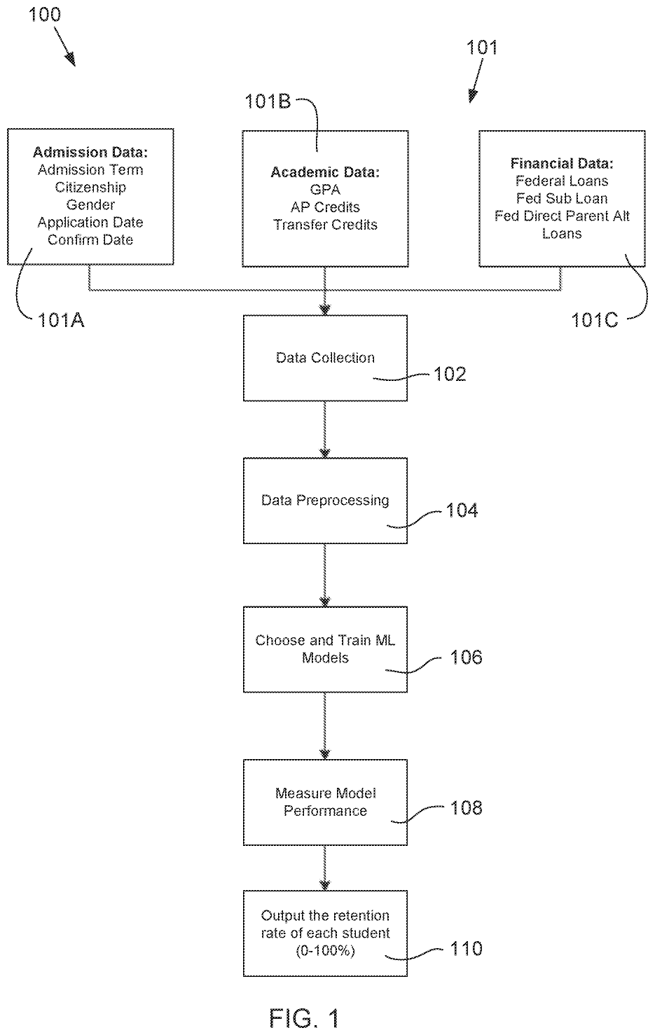

As shown in FIG. 1, a method of predicting the retention rates of students attending an educational institution is generally designated by the numeral 100. The method 100 includes data collection 102, which includes receiving an initial dataset 101. The initial dataset 101 includes data related to a cohort of students attending the educational institution. In some embodiments, the initial dataset 101 includes admission data 101A, academic data, 101B, and financial data 101C, which are collected and merged together. Admission data 101A includes data related to admission term, citizenship, gender, application date, confirmation date, etc. Academic data 101B includes data related to grade point average (GPA), advanced placement (AP) credits, transfer credits, etc. Financial data 101C includes data related to how tuition payments are made, such as through federal loans, third-party loans, scholarships, non-financed, etc.

In some embodiments, the method 100 includes data preprocessing 104. In some embodiments, after the data has been merged, missing values are replaced with mode (for character variables) and median (for numeric variables). Any duplicate records are removed. Students with different records under different departments are verified and combined. The formats of all variables are transformed into either character or numeric. Furthermore, character variables are encoded to fit the prediction model discussed herein. For numeric variables, scale variables are normalized to improve model performance. All prepared variables are combined and stored as the initial dataset.

The method 100 includes training a machine-learning (ML) predictive algorithm 106. In some embodiments, the ML algorithm is a classification algorithm. In some embodiments, the ML algorithm is a gradient boosting algorithm configured for speed and performance. In some embodiments, the ML algorithm is an extreme gradient boosting classification algorithm. In some embodiments, the predictive algorithm combines multiple weak models to generate a strong model by sequentially adding models to the ensemble, each of which are trained to correct the errors of the previous models. The final strong model is a weighted combination of the individual models and is more accurate than any of the individual models.

In some embodiments, before the predictive algorithm is trained, variables are selected from the initial dataset based on cohorts and years that are interested. Preferably, only students who are currently attending the educational institution will be filtered and used, in other words, students who have left before the target year will not be included in the modeling. The filtered initial dataset is divided into a training dataset and a testing dataset. In some embodiments, the training dataset includes 80% random selected observations and the testing dataset includes the remaining 20%. In some embodiments, because the split is random and most students are staying, the training and testing datasets are resampled to deal with the problem of imbalance.

After the training and testing datasets are resampled, the predictive algorithm is trained. In some embodiments, training the predictive algorithm includes processing the training dataset with the predictive algorithm to generate a training model, validating the training model, and generating a prediction model based on the validated training model. In some embodiments, validating the training model is performed with a Cross Validation method, such as a K-fold Cross Validation method. In some embodiments, the validation method includes dividing the training dataset into a plurality of subsets, randomly selecting a first of the plurality of subsets as a first test subset and selecting the remaining ones of the plurality of subsets as a first training subset, training the training model via the first training subsets to generate a first training sub-model, validating the first training sub-model via the first test subset, and repeating the above validation steps for each of the remaining ones of the plurality of subsets to generate a plurality of validated training sub-models. The prediction model is generated based on the plurality of validated training sub-models, and preferably the prediction model is a weighted combination of the plurality of training sub-models.

In some embodiments, hyperparameter tunning and cross validation are performed on the predictive algorithm to improve the prediction model's performance. In some embodiments, Grid Search Cross Validation is used to find an optimal combination of hyperparameter values to produce an optimal result on the training dataset. Hyperparameter tunning also helps improve the computation speed of modeling. In some embodiments, confusion metrics are used to validate the model performance, and permutation importance is calculated for importance analysis.

After the predictive algorithm is trained and the prediction model generated, the method 100 includes performing the prediction model 108, which includes processing the testing dataset via the prediction model. The prediction model 108 then outputs a prediction results dataset that corresponds to the retention rate of each student, shown as step 110 of the method 100 in FIG. 1. In some embodiments, the retention rate of each student is presented as a percentage (0-100%) likelihood of that student staying at the educational institution. In some embodiments, the prediction results dataset is presented as a listing of the students' retention rates organized from most likely to leave the educational institution to least likely to leave the educational institution. In some embodiments, the method 100 further includes filtering the top 15% of the students most likely to leave the educational institution to form a watchlist.

In some embodiments, the method 100 further includes periodically updating the prediction results dataset. After a predetermined period of time, such as two weeks, five weeks, after each semester, after each school year, etc., the admission data 101A, academic data 101B, and financial data 101C is updated to form an updated dataset. In some embodiments, the updated dataset is preprocessed as discussed above regarding the initial dataset. The updated dataset is divided into an updated training dataset and an updated testing dataset, and the predictive algorithm is trained, or retrained, as discussed above, via the updated training dataset to generate an updated prediction model. The updated testing dataset is processed via the updated prediction model to output an updated prediction results dataset that corresponds to the updated retention rates of the students still attending the educational institution after the predetermined period of time.

In some embodiments, the method 100 further includes receiving real-time data. The real-time data includes learning management system (LMS) data and early warning system (EWS) data. The LMS data includes data related to students' log results, including log in, log out, and session expired, student ID, student name, IP address used, etc. The EWS data includes data related to student information, course ID, instructor ID, warning types, datetime, and warning details. In some embodiments, the real-time data is updated hourly, daily, weekly, etc. After receiving the real-time data, the method 100 includes analyzing the real-time data, and adjusting the prediction results dataset based on the analyzed real-time data. For example, if a student's LMS login frequency is lower than a predetermined threshold, then a 1% probability of that student leaving is added to their retention rate. In another example, one EWS appearance for a student results in a 2% probability of that student leaving being added to their retention rate.

Embodiments of the method 100 described herein may be implemented in a computer-readable storage device having stored thereon instructions that when executed by one or more processors perform the method 100. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

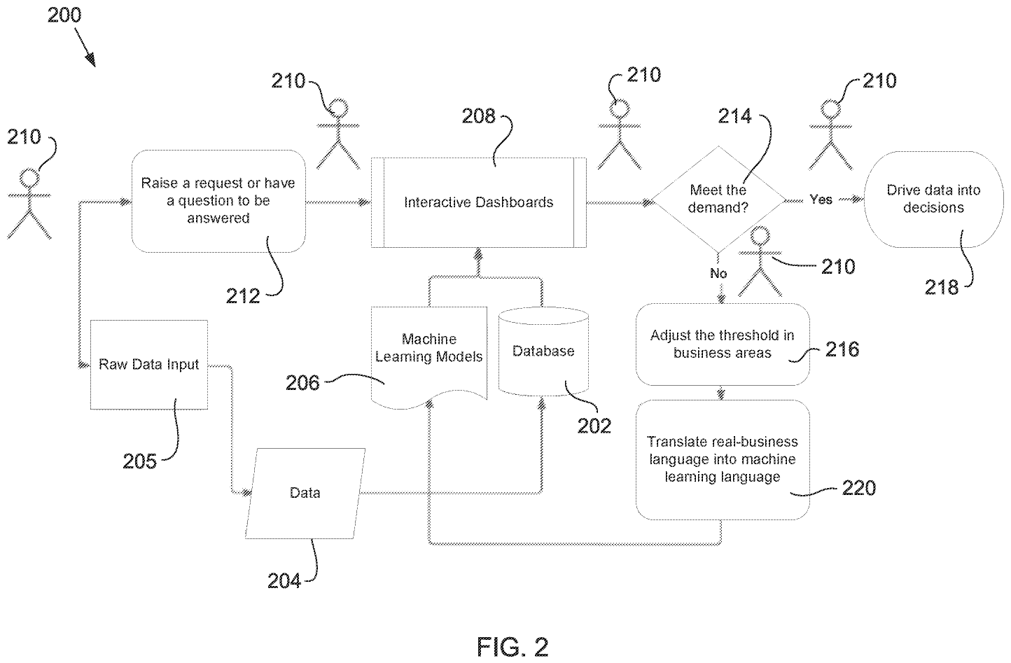

As shown in FIG. 2, a machine-learning-based (ML-based) human-in-the-loop system for predicting student retention is generally designated by the numeral 200. The system 200 includes a database 202 that stores data 204, such as the initial dataset 101 of method 100 discussed above. In some embodiments, raw data 205 is input into system 200, which is then preprocessed into data 204 as discussed above regarding method 100. The system 200 includes ML prediction model 206, which are generated and trained as discussed above regarding method 100. The prediction results dataset of method 100 is generated by the ML prediction model 206 and output to an interactive dashboard 208 for viewing by users 210 on a display of a user device, such as a computer, laptop, tablet, smart phone, etc. In some embodiments, the interactive dashboard 208 is part of software application or a webpage.

FIG. 2 also shows a process for using the system 200 according to an exemplary embodiment. A user 210 raises a request and has a question in mind to answer 212. The user can turn to the interactive dashboard 208 to view current status, where baseline models and visualizations are presented. Based on current results, the user 210 assesses if their demand is met 214 and can adjust the results to better meet their specific needs 216, given limited human resources and dynamics of changing students' data. The system 200 includes a translation model 220 configured to translate real-life business needs into machine learning language/metrics and reflect on the machine learning models. Users 210 can iterate the process until they feel confident to make a decision 218. Thus, system 200 and method 100 increase a user's ability to accurately predict the retention rate of students, and through analysis of the data and presented results, determine how attrition contributes to the predicted retention rate.

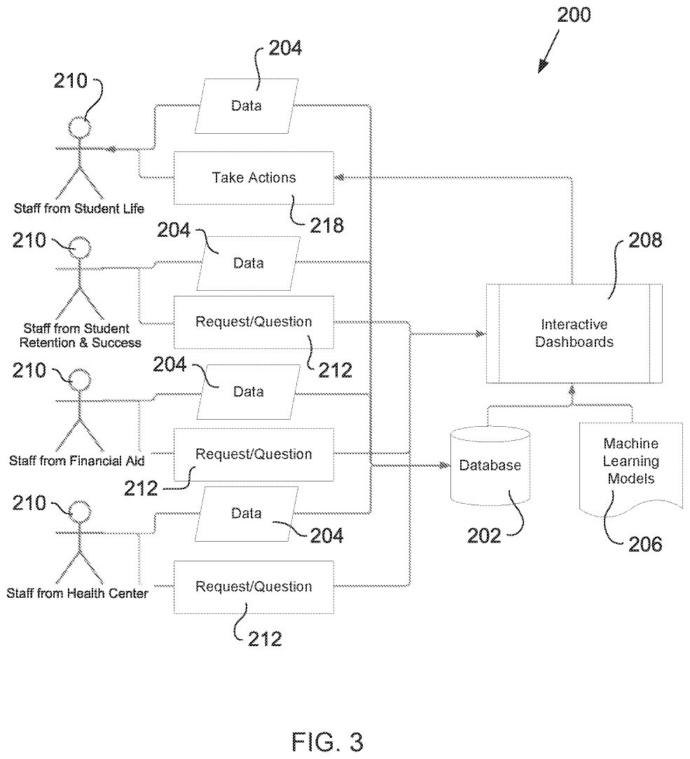

Users 210 can come from cross-functional departments. For example, users 210 include administration staff and research and leadership staff. Administration staff includes admission office staff, first-year experience office staff, student retention and success office staff, financial aid office staff, health center staff, learning and teaching center staff, diversity and inclusion office staff, student life office staff, class deans, IT staff, etc. Research and leadership staff includes institutional research staff, external research group staff, school management staff, etc. Through system 200, users 210 from different departments can work together within the same data pool while the certain compliance requirements and data synchronization are maintained. For example, student life experts may ask the question, “Are students who have poor academic performance experiencing difficulties in finance?” They can check the interactive dashboards for an answer and make action plans. The answer could be “yes” or “no.” The user does not need to wait until data is gathered and analyzed by iterations. Users 210 can use system 200 in sequence to make the decision, or work in parallel to feed the data and information to the system 200. FIG. 3 shows an exemplary embodiment of users 210 working in parallel. As shown, users 210 from student life, student success and retention, financial aid, and health center are using system 200.

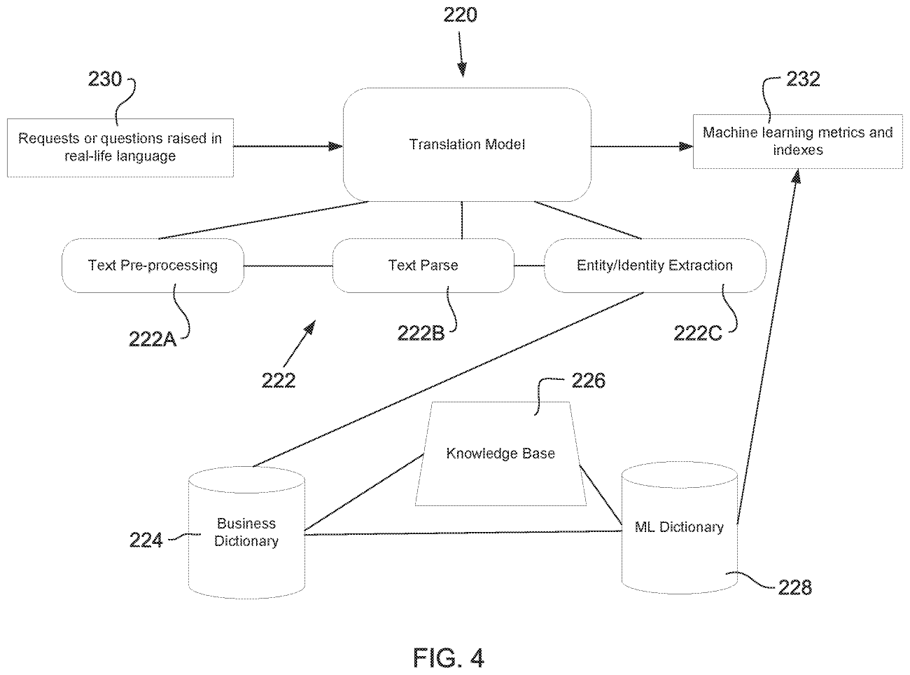

FIG. 4 shows the translation model 220 of system 200. The translation model 220 includes natural language processing (NLP) algorithms 222 configured to understand human natural language (i.e., text). In some embodiments, the NLP algorithms 222 include text preprocessing 222A, text parse 222B, and entity/identity extraction 222C algorithms. The translation model 220 further includes a knowledge base 226, a business dictionary 227, and a ML dictionary 228. In some embodiments, the knowledge base 226 is pre-built and customized based on the needs, data, resources, etc., of a specific educational institution. The translation model 220 receives as input from a user 210 a request or question presented in a human natural language 230, and after processing, the request or questions is translated into ML metrics and indexes 232 for use by the predictive models discussed herein.

In an exemplary embodiment, a user 210 of system 200 poses the question of how to improve the first-year retention rate for freshman students from 90% to 93%. In response, the NLP algorithms 222 of translation model 220 perform text parsing to fetch keywords and numbers. The translation model 220 then explores the knowledge base 226, which is customized to define the keywords and make them quantitative. In some embodiments, system 200 includes a predefined rule set that defines the first-year retention rate to calculate the percentage of students who are still registered and remained on the list after the fifth week in second-year compared to the cohort total. Based on the calculation results, system 200 defines ML metrics to evaluate the problem. In this exemplary embodiment, system 200 uses recall and efficiency to measure, rather than the common measurement of accuracy in the modeling evaluation, because the outcome variable retention rate is highly unbalanced. In some embodiments, the system 200 self-adapts after several iterations and determines additional metrics. After the baseline model is built and metrics to evaluate are defined, system 200 outputs the results to the interactive dashboard 208 for viewing by the user 210. The user 210 can then determine a student, or a group of students, who need more attention and resources.

Accordingly, embodiments of the present technology improve the training of ML algorithms to accurately predict student retention rates, and significantly accelerates the process of stakeholders (e.g., users 210) to understand the business situation and make action plans. Based on the pre-built and incremental knowledge base 226 customized for a specific educational institution, system 200 can leverage the trained NLP algorithms 222 and transfer the learning result to provide quick and quantitative metrics to the stakeholders.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. The term “exemplary embodiment” describes an embodiment by way of example, and is not necessarily meant to describe a preferred, or best, embodiment.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. A method of predicting the retention rates of students attending an educational institution, the method comprising:
receiving an initial dataset related to a cohort of students attending the educational institution;
dividing the initial dataset into a training dataset and a testing dataset;
training a predictive algorithm via the training dataset to generate a prediction model; and
processing the testing dataset via the prediction model to output a prediction results dataset.

2. The method of claim 1, wherein the prediction results dataset comprises a listing of the cohort of students organized from most likely to leave the educational institution to least likely to leave the educational institution; and
wherein the method further comprises filtering a percentage of the prediction results dataset to identify a watchlist of students likely to leave the educational institution.

3. The method of claim 2, wherein the watchlist comprises the top 15% of the cohort of students most likely to leave the educational institution.

4. The method of claim 1, wherein training the predictive algorithm comprises:
processing the training dataset with the predictive algorithm to generate a training model;
validating the training model; and
generating the prediction model based on the validated training model.

5. The method of claim 4, wherein validating the training model comprises:
dividing the training dataset into a plurality of subsets;
randomly selecting a first of the plurality of subsets as a first test subset and selecting the remaining ones of the plurality of subsets as a first training subset;
training the training model via the first training subsets to generate a first training sub-model;
validating the first training sub-model via the first test subset; and
repeating the randomly selecting, training, and validating steps for each of the remaining ones of the plurality of subsets to generate a plurality of validated training sub-models.

6. The method of claim 5, wherein the prediction model comprises a weighted combination of the plurality of validated training sub-models.

7. The method of claim 1, wherein before the training step the training dataset and the testing dataset are resampled from the initial dataset.

8. The method of claim 1, wherein the initial dataset comprises admission data, academic data, and financial data for each student of the cohort of students.

9. The method of claim 1, further comprising preprocessing the initial dataset to filter and transform the initial dataset to a format compatible with the predictive algorithm.

10. The method of claim 1, further comprising:
receiving, after a predetermined period of time, an updated dataset related to the cohort of students;
dividing the updated dataset into an updated training dataset and an updated testing dataset;
retraining the predictive algorithm via the updated training dataset to generate an updated prediction model; and
processing the updated testing dataset via the updated prediction model to output an updated prediction results dataset.

11. The method of claim 10, wherein the updated dataset comprises updated admission data, updated academic data, and updated financial data for each student of the cohort of students still attending the educational institution after the predetermined period of time.

12. The method of claim 10, further comprising preprocessing the updated dataset to filter and transform the updated dataset to a format compatible with the predictive algorithm.

13. The method of claim 10, wherein before the retraining step the updated training dataset and the updated testing dataset are resampled from the updated dataset.

14. The method of claim 1, further comprising:
receiving, in real-time, learning management system (LMS) data and early warning system (EWS) data for each student of the cohort of students;
analyzing the LMS data and the EWS data; and
adjusting the prediction results dataset based on the analyzed LMS data and EWS data.

15. The method of claim 1, wherein the training dataset comprises 80% of the initial dataset and the testing dataset comprises 20% of the initial dataset.

16. The method of claim 10, wherein the updated training dataset comprises 80% of the updated dataset and the updated testing dataset comprises 20% of the updated dataset.

17. A computer readable storage device having stored thereon instructions that when executed by one or more processors result in the following operations comprising the method of claim 1.
